(19) United States
(12) Patent Application Publication
(10) Pub. No.: US 2026/0307272 A1
(43) Pub. Date: Oct. 8, 2026

(54) ADDITIVE MANUFACTURING DEPOSITION HEAD WITH SUBSTANTIALLY SURROUNDING COMPACTION SURFACE FOR POLY-DIRECTIONAL DEPOSITION

(71) Applicant: Electroimpact, Inc., Mukilteo, WA (US)

(72) Inventors: Ryan L. BISCHOFF, Shoreline, WA (US); Andrew PURVIS, Mukilteo, WA (US); Michael M ZIEVE, Seattle, WA (US)

(73) Assignee: Electroimpact, Inc., Mukilteo, WA (US)

(21) Appl. No.: 19/171,092

(22) Filed: Apr. 4, 2025

(51) Int. Cl. B25J 15/00; B25J 11/00; B25J 13/08; B33Y 10/00; B33Y 30/00; B33Y 40/00

(52) U.S. Cl. CPC B25J 15/0019; B25J 11/005; B25J 13/08; B33Y 10/00; B33Y 30/00; B33Y 40/00

(57) ABSTRACT

An additive manufacturing machine (AMM) includes a deposition head with a nozzle outlet and one or more compaction members having compaction surfaces. The compaction surface(s) are positioned at least 270 degrees around the nozzle outlet. A motion system moves the deposition head in multiple degrees of freedom coordinated by the control system. During operation, additive manufacturing material is deposited from the nozzle outlet, and the compaction surfaces compact the newly deposited material as the deposition head moves poly-directionally along a deposition path, effecting compaction of the deposited material regardless of the direction of head movement, improving material properties.

### BACKGROUND

Additive manufacturing machines (AMM) often deposit material in a poly-directional manner, presenting persistent challenges in achieving consistent layer height and a smooth surface finish of the newly deposited material. Consistent layer height is crucial for dimensional accuracy, interlayer bonding, and preventing collisions between the deposition head and the previously deposited layers of the work piece. Existing compaction members are inadequate for poly-directional processes due to their complexity, bulk, and expense or are otherwise limited to a unidirectional process.

### SUMMARY OF THE DISCLOSURE

This Summary introduces a selection of concepts in a simplified form to provide a basic understanding of some aspects of the present disclosure. This Summary is not an extensive overview of the disclosure and is not intended to identify key or critical elements of the disclosure or to delineate the scope of the disclosure. This Summary merely presents some of the concepts of the disclosure as a prelude to the Detailed Description provided below.

This disclosure relates to an improved additive manufacturing machine (AMM), specifically designed to compact newly deposited material along complex shapes and multi-directional paths. Traditional additive manufacturing machines without suitable compaction solutions often struggle to achieve consistent layer heights, smooth surface finishes, and strong bonding between layers. The disclosed AMM overcomes these challenges through a compaction surface configuration which enables a highly controlled and repeatable compaction of the deposited additive manufacturing material during poly-directional deposition.

These compaction surfaces substantially surround the nozzle opening, covering at least 270 degrees around its perimeter, ensuring immediate and consistent pressing of newly deposited material into place, regardless of the direction of the nozzle's movement. By compacting the deposited material uniformly, the compaction surfaces ensure precise layer heights, smoother finishes, and stronger adhesion between layers, ultimately producing more accurate and durable printed parts.

Furthermore, the disclosed AMM offers adjustable compaction surfaces to precisely control the height and amount of compaction applied and the resulting layer thickness. In certain embodiments, the compaction surfaces may also incorporate active heating or cooling elements, providing further control over the material deposition process. Collectively, these enhancements significantly improve the quality, dimensional accuracy, and mechanical strength of additively manufactured parts, especially those involving intricate geometries or poly-directional printing paths.

According to an embodiment, an additive manufacturing machine includes a deposition head, a motion system, and one or more compaction members. The deposition head has a deposition nozzle, which in turn has a nozzle outlet. The deposition head is configured to deposit additive manufacturing material through the nozzle outlet onto a deposition surface. The motion system is operationally coupled to the deposition head and is configured to position and move the deposition head with multiple degrees of freedom along a poly-directional deposition path in at least two dimensions for the deposition of the additive manufacturing material. The one or more compaction members each have at least one compaction surface which, individually or collectively, is disposed at least 270 degrees around the nozzle outlet. The one or more compaction members is/are, individually or collectively, oriented to compact additive manufacturing material that is newly deposited by the deposition nozzle as the deposition head is moved along the deposition path.

According to an embodiment, a method of additive manufacturing includes providing an additive manufacturing machine (AMM). The AMM has a deposition head with a nozzle outlet, a motion system configured to move the deposition head in multiple degrees of freedom; and one or more compaction members. Each of the compaction members has at least one compaction surface and, individually or collectively, substantially surrounding the nozzle outlet. The method further comprises moving the deposition head in multiple degrees of freedom using the motion system. For example, the degrees of freedom utilize multiple arrangements of rotational and prismatic elements. The method further includes depositing additive manufacturing material from the nozzle outlet onto a deposition surface. In addition, the method includes compacting the newly deposited material with at least one compaction surface during poly-directional movement of the deposition head effected by the motion system.

Further scope of applicability of the presently disclosed devices and methods will become apparent from the Detailed Description given below. However, it should be understood that the Detailed Description and specific examples, while indicating preferred embodiments of the presently disclosed devices and methods, are given by way of illustration only, since various changes and modifications within the spirit and scope of the devices and methods will become apparent to those skilled in the art from the Detailed Description.

### BRIEF DESCRIPTION OF THE DRAWINGS

These and other objects, features and characteristics of the present disclosure will become more apparent to those skilled in the art from a study of the following Detailed Description in conjunction with the appended claims and drawings, all of which form a part of this specification. In the drawings:

FIG. 1 is a schematic view of an additive manufacturing machine, according to an embodiment;

FIG. 2 is a perspective view of a partial deposition head, according to an embodiment;

FIG. 3 is a cross-sectional view of a deposition head, according to an embodiment;

FIGS. 4A and 4B are cross-sectional views of a deposition head with an adjustment mechanism, according to an embodiment, in which FIG. 4A shows a compaction member in a lower position, and FIG. 4B shows a compaction member in a raised position relative to a nozzle outlet;

FIGS. 5A and 5B are comparative side views of a deposition head, where FIG. 5A shows a deposition head with a substantially surrounding compaction member, according to a disclosed embodiment, and FIG. 5B shows a conventional deposition head without a compaction member;

FIGS. 6A and 6B are cross-sectional views of a deposition head with multiple compaction members, according to an embodiment, where FIG. 6A shows the compaction members in a first state, and FIG. 6B shows the compaction members in a second state;

FIG. 7 is a perspective view of a deposition head with multiple compaction members, a deployment mechanism, and pneumatic connections for independent thermal fluid control of each compaction member, according to an embodiment;

FIG. 8 is a partial cutaway side view of a deposition head with a compaction member and an adjustment mechanism, according to an embodiment;

FIGS. 9A and 9B are perspective views of a deposition head with multiple compaction members, a deployment mechanism, and an adjustment mechanism showing two different configurations of the compaction members and their corresponding compaction surfaces, according to an embodiment;

FIG. 10 is a cross-sectional view of a deposition head, showing a nozzle outlet, a compaction member, and localized thermal management system for heating and/or cooling the region between the nozzle outlet and the compaction member, according to an embodiment;

FIG. 11 is a top-down simplified view of a nozzle outlet, illustrating poly-directional movement of the deposition head;

FIG. 12 is a simplified side view illustrating the relationship between a deposition head, a nozzle outlet, newly deposited additive manufacturing material, a substrate, and a deposition surface; and

FIG. 13 is a partial perspective view of a deposition nozzle having an integrated compaction member, according to an embodiment.

### DETAILED DESCRIPTION

Various examples of the disclosed devices and methods will now be described. The following description provides specific details for a thorough understanding and enabling description of these examples. One skilled in the relevant art will understand, however, that the presently disclosed devices and methods may be practiced without some of these details. Likewise, one skilled in the relevant art will also understand that the presently disclosed devices and methods can include many other features not described in detail herein. Additionally, some well-known structures or functions may not be shown or described in detail below to avoid unnecessarily obscuring the relevant description.

Descriptions of well-known starting materials, processing techniques, components and equipment may be omitted so as not to unnecessarily obscure the key details. It should be understood, however, that the detailed description and the specific examples, while indicating (e.g., preferred) embodiments, are given by way of illustration only and not by way of limitation. Various substitutions, modifications, additions and/or rearrangements within the spirit and/or scope of the underlying inventive concept will become apparent to those skilled in the art from this disclosure.

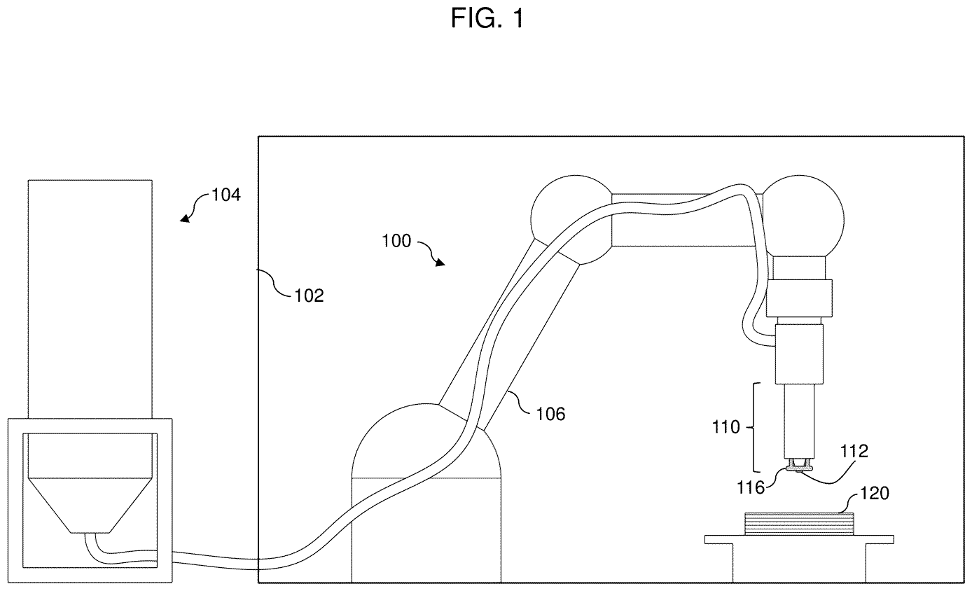

In general, similar reference numbers in the figures and the description below refer to the same or similar features. For example, element 110 in FIG. 1 is a deposition head and elements 210, 310, 410, etc. in subsequent figures are also deposition heads, and may be the same deposition head as 110 except where explicitly or practically distinct.

Existing poly-directional additive manufacturing processes often struggle with inadequate interlayer bonding, inconsistent layer heights, irregular surface finishes, and compromised dimensional accuracy. The disclosed additive manufacturing machine (AMM) addresses these limitations by providing significant advantages specifically for poly-directional additive manufacturing processes. By integrating one or more compaction members with compaction surfaces substantially surrounding the nozzle outlet, this concept and arrangement ensures consistent compaction, uniform layer height, enhanced surface finish, and precise dimensional accuracy, irrespective of the deposition direction. Importantly, these improvements are maintained even during complex, multi-directional deposition paths, resulting in improved interlayer adhesion, minimized surface irregularities, and optimized mechanical properties of the workpiece. Additionally, the disclosed AMM, through its control system, allows for precise and versatile management of the deposition process. This management is achieved by controlling key operational parameters such as: the height of the one or more compaction surfaces relative to the nozzle outlet, applied compaction force, control of one or more thermal management systems, deployment state of the one or more compaction members, additive manufacturing material deposition rate, and deposition head traversal speed. Such thermal control includes adjusting the energy output supplied to distinct thermal management systems, which may include, but are not limited to, systems integrated with respective compaction members, localized thermal systems acting on the region between the nozzle and compactor, and/or systems controlling deposition head or nozzle temperature. Overall, this parameter control, and specifically the height-adjustable and thermally controlled compaction surfaces, enhances part quality, process stability, and versatility across a wide spectrum of materials and deposition geometries.

Turning to the figures, FIG. 1 is a schematic view of an additive manufacturing machine (AMM) 100 and its overall relationship with several components, particularly the compaction member 116. The AMM 100 includes a deposition head 110 with a deposition nozzle 112, a motion system 106, and a compaction member 116. The compaction member 116 and its compaction surface is disposed at least partially around a lower extent of the deposition 112 and is intended to compact newly deposited additive manufacturing material after it has been deposited onto a deposition surface 120 during poly-directional movement of the deposition head 110 effected by the motion system 106 and coordinated by the control system (not shown).

The compaction surface (sometimes described as a consolidation surface or smoothing surface) is configured to compact, smooth, and consolidate the deposited material to improve interlayer adhesion with both a substrate layer and the subsequent layer(s) to be deposited on top of it, control geometry, reduce voids, smooth the surface, and enhance the mechanical, structural, or surface properties of the printed part. The compaction surface physically engages the deposited material to apply compressive force, smooth the top or side surfaces, reshape the cross-sectional profile, flatten irregularities, or merge adjacent deposition passes. In some embodiments, the consolidation surface may further refine dimensional accuracy, reduce surface roughness, and promote consistent material deposition by reflowing or redistributing still-malleable material.

In some embodiments, additive manufacturing material is stored in a primary material supply 104 and transferred across the motion system 106 to the deposition head 110. Those skilled in the art will appreciate that the motion system 106 may include an articulated robot arm as shown but could be any motion system such as a traditional cartesian machine or custom machine. Furthermore, a separate primary material supply may be unnecessary in some embodiments. The scope of this disclosure is applicable to additive manufacturing that uses materials such as pelletized materials, filamentary materials, paste-like materials, wire materials, powdered materials, or flowable materials extruded through a nozzle. Any motion system with a deposition head configured to deposit additive manufacturing material through the outlet of a deposition nozzle (such as deposition nozzle 112) on a deposition surface may use a compaction member(s) within the scope of this disclosure.

The deposition head 110, although primarily responsible for material deposition, may be configured to provide any of multiple different functions including but not limited to, localized sensing, localized heating, bonding agent application, and reinforcement application. A deposition head 110, consistent with the disclosure, may further include versions of each of these functions in an implementation that substantially surrounds the deposition nozzle 112. For example, a heating ring and temperature sensing ring that substantially or fully surround the deposition nozzle 112. Other functions and corresponding structural enhancements of the deposition head 110 may be used in combination with the described compaction member(s) 116.

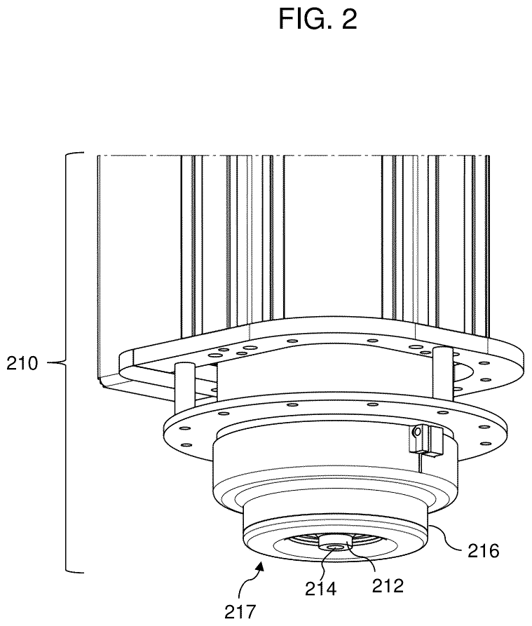

FIG. 2 shows a close-up view of a deposition head 210 (corresponding to deposition head 110 in FIG. 1), deposition nozzle 112 with nozzle outlet 214, compaction member 216 and its corresponding compaction surface 217. Those of the art will understand that while one compaction surface is shown, the presently disclosed devices and methods further apply to implementations of compaction members that have a plurality of compaction surfaces arranged in any manner including sectional, concentric, and side by side. The compaction surface 217 is positioned to substantially surround the deposition nozzle 212. This arrangement is beneficial for poly-directional additive manufacturing material deposition, as it ensures that the compaction member will generally trail the nozzle outlet 214 and compact the newly deposited additive manufacturing material, regardless of the direction of movement. While FIG. 2 shows a concentric and circular compaction member, other shapes and positions are possible, provided they substantially surround (particularly the outlet 214 of) the deposition nozzle 212 as defined herein, including non-concentric and/or non-circular compaction members. Those skilled in the art will recognize that other nozzle outlet geometries and configurations may be used. For example, instead of a single circular nozzle, a multi-orifice nozzle or a nozzle with a non-circular orifice (e.g., elliptical, rectangular, or slit-shaped) could be employed to alter the deposition profile or increase throughput.

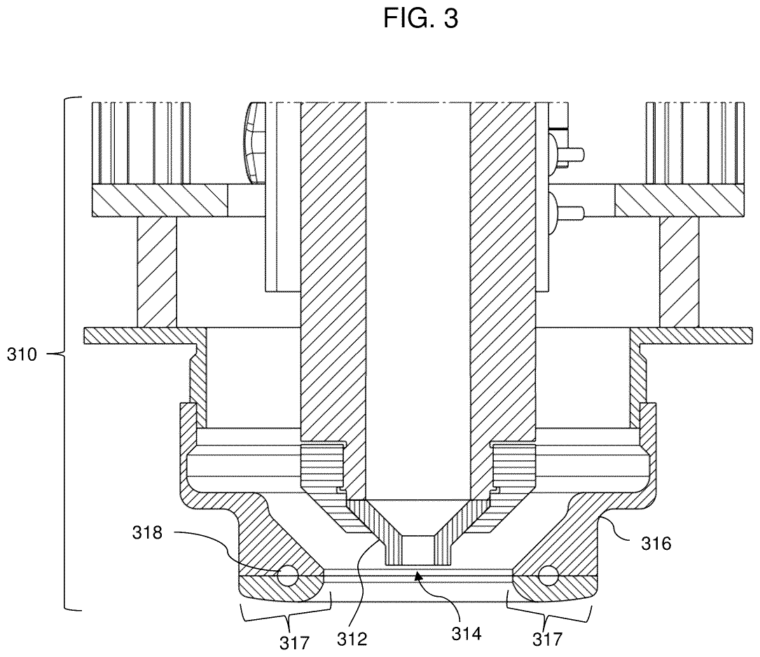

FIG. 3 shows a cross-sectional view of a deposition head 310, deposition nozzle 312 having a nozzle outlet 314, compaction member 316 and its corresponding compaction surface 317. An internal passageway 318 through the compaction member 316 facilitates the flow of a thermal fluid. Such flow actively heats or cools the compaction member 316 and compaction surface 317 constituting one embodiment of a thermal management system integrated with the compaction member. Those skilled in the art will recognize that circulation of thermal fluid is one of several possible thermal management systems employing active heating or cooling schemes that can be integrated into a compaction member 316. Alternative or additional heating/cooling structures may include electrical coils, convection passageways, etc. as part of such thermal management systems to control the temperature of the compaction surface 317 and thus of deposited additive manufacturing material. Furthermore, multiple thermal management system instances, potentially forming distinct thermal zones, or respectively different types of heating/cooling systems could be implemented to allow for independent control of different zones within the compaction member(s) 317 enabling more precise thermal management of the newly deposited additive manufacturing material. For example, a portion of the compaction surface that leads the nozzle outlet 314 may be heated and/or a portion of the compaction surface(s) 317 that trails the nozzle outlet 314 may be cooled. Furthermore, temperature sensors (not shown) including but not limited to pyrometers, thermocouples, or IR cameras can be used for thermal feedback facilitating closed loop temperature control based on temperature measurements of one or more of the following: the compaction member(s), compaction surface(s), substrate, nozzle outlet, or the newly deposited additive manufacturing material. Thermal feedback and/or feedback from inspection camera(s) (not shown) can also be used by the control system to adjust operational parameters such as the flow rate of additive manufacturing material through the nozzle outlet, the deposition head traversal speed, a height of the one or more compaction surfaces relative to the nozzle outlet, applied compaction force by the compaction surface, or a deployment state of the one or more compaction members.

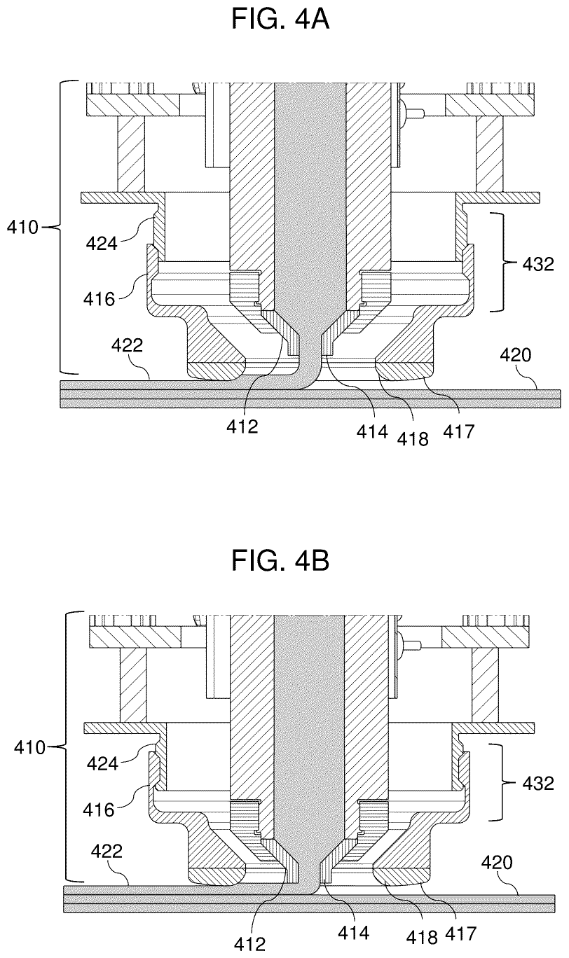

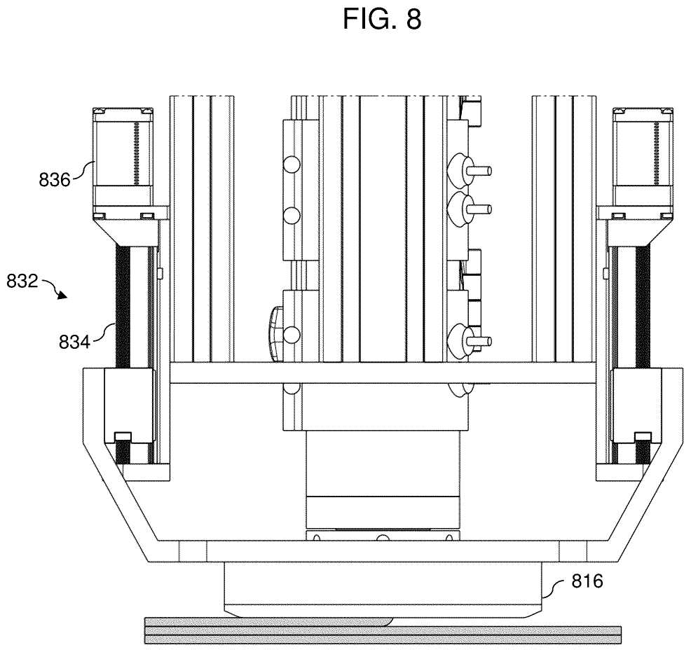

FIGS. 4A & 4B show two cross-sectional views of a deposition head 410 having a deposition nozzle 412 with nozzle outlet 414, compaction member 416 and a compaction surface 417 of the compaction member 416. The compaction surface 417 features an internal ramp 418. As the deposition head 410 moves relative to the deposition surface 420, the ramp 418 gradually contacts the newly deposited additive manufacturing material 422, applying a downward force and compacting it to a consistent height. Furthermore, the vertical position of the compaction member 416 relative to the nozzle outlet 412 is adjustable via an adjustment mechanism 432. In this embodiment the adjustment mechanism 432 is a threaded mounting structure 424. In FIG. 4A, the compaction member 416 is positioned at a lower vertical height relative to the nozzle outlet 414, such that the distance between the compaction surface 417 and the nozzle outlet 414 is greater than the corresponding distance shown in FIG. 4B. In FIG. 4B, the compaction member 416 is set to a higher vertical position, thereby reducing the distance between the compaction surface 417 and the nozzle outlet 414. With a similar deposition rate, the configuration in FIG. 4B results in greater compaction and consolidation of the extruded material, producing a deposited layer with a reduced height or thickness compared to the configuration of FIG. 4A. Those skilled in the art will recognize that other adjustment mechanisms may be used such as a linear actuator, a stepper motor, a servo motor, etc. (See FIG. 8).

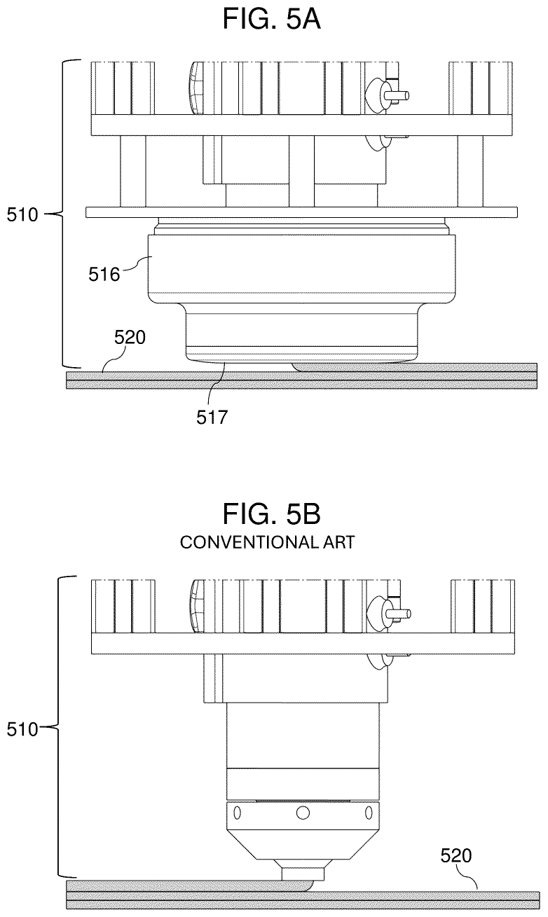

FIGS. 5A & 5B are comparative side views of a deposition head. As shown in FIG. 5A, the compaction surface 517, by substantially surrounding the nozzle outlet (not shown), compacts the material in poly-directional movement of deposition head 510 relative to the deposition surface 520. While a compaction surface 517 that surrounds the nozzle outlet (not shown in FIG. 5A) in 360 degrees is ideal, as it compacts the material in all directions of machine movement, an incomplete but substantial encompassment may nevertheless ensure effective compaction in most directions. In comparison, FIG. 5B shows a conventional deposition head 510 without a compaction member. In this conventional design, the deposited material's shape and distribution depend primarily on the flow characteristics from the nozzle and the geometry of the nozzle outlet itself. This geometry, which, as in the presently disclosed system, may include nozzle outlets with specific shapes or cutouts (not shown), can partially control and influence the shape and form of the deposited material as it exits the nozzle outlet (e.g., 214, 314, 414). However, nozzle geometry alone does not provide the uniform compaction pressure necessary for optimal material density and surface finish.

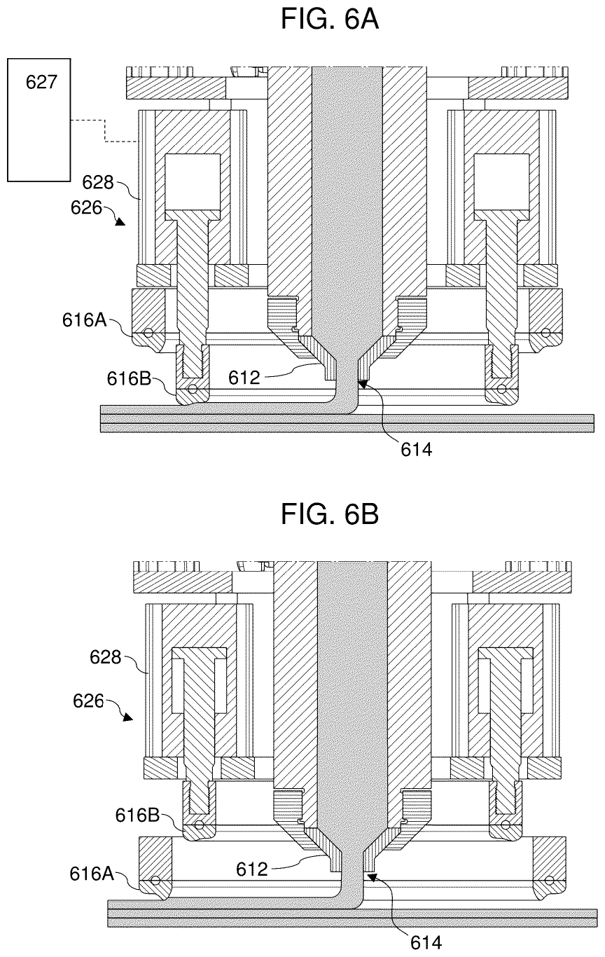

FIGS. 6A & 6B illustrate two cross-sectional views of a deposition head 610 with multiple compaction members 616a, 616b and a deployment mechanism 626. These compaction members 616a, 616b and their corresponding compaction surfaces 617a, 617b, either individually or collectively, substantially surround the deposition nozzle 612. Each compaction member, while not required, can have different characteristics, such as different material composition, different ramp angles, different diameters, different shapes, different positions relative to the nozzle outlet 612 including non-concentric arrangements, and different heating and/or cooling systems. A deployment mechanism 626 is also shown, actuated by a control system 627, that can extend or retract individual compaction members, or combinations of compaction members, to engage the desired compaction member(s) with the newly deposited manufacturing material. Such control system 627 may incorporate discrete and/or programmable circuitry, pneumatic actuators and/or valves, positional sensors, and the like. In some embodiments, the deployment mechanism uses pneumatic cylinders 628 to extend the compaction members. Those skilled in the art will recognize that other methods of selecting, extending, and retracting the compaction members may be implemented consistently with the scope of this disclosure. Those skilled in the art will further recognize that any number of a plurality of compaction members, each with one or more compaction surfaces, may be employed in an AMM within the scope of this disclosure.

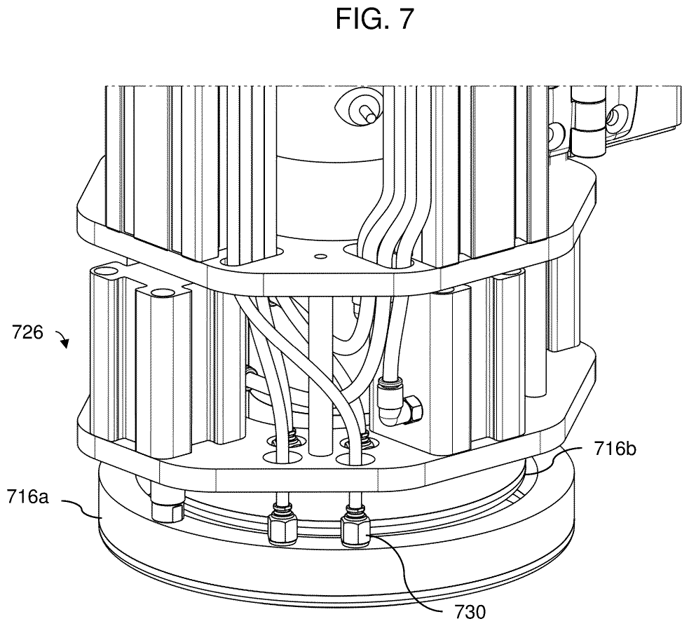

FIG. 7 illustrates a perspective view of a deposition head 710 having multiple compaction members 716a, 716b and a deployment mechanism 726. (Note: a control system such as control mechanism 627 may be employed to operate the deployment mechanism 726.) The deposition head 710 may include a combination of structural features that constitute or facilitate thermal management systems for the discrete compaction members 716a, 716b. Cooling line and heating line connections 730 on the top of the compaction members convey thermal fluid to, from and through an internal passageway (not shown) in the compaction members 716a, 716b to actively control temperature thereof. Importantly, each compaction member 716a, 716b may have a respective thermal fluid circuit that facilitates respective thermal control of each compaction member, for example, as discussed above with respect to FIG. 3. One or more temperature sensors may be included in one or each discrete compaction member 716a, 716b for active monitoring or closed loop feedback (e.g., in cooperation with a thermal management control system, not shown). Those skilled in the art will recognize that circulation of thermal fluid is one of several possible thermal management systems (active heating or cooling schemes) that can be integrated into—or added to—the compaction member(s) 716a, 716b. Alternative or additional temperature control structures may be employed within the scope of the disclosure. For example, electrical coils, convection passageways, etc. may be implemented to control the temperature of the compaction members 716a, 716b. Some embodiments may include a plurality of thermal circuits for multiple thermal zones for each compaction member. Multiple heating and cooling circuits may be provided within each compaction member or zone to allow for independent control of different zones within the compaction member (for example heating a leading edge and cooling a trailing edge), resulting in more precise thermal management of newly deposited additive manufacturing material.

FIG. 8 is a partial cutaway side view of a deposition head 810 with a compaction member 816 that is positioned by an adjustment mechanism 832. The adjustment mechanism 832 may include a stepper motor 836 configured to, when engaged, turn a ball screw assembly 834 to accurately adjust a (vertical, in the figure) position of the compaction member 816 relative to the nozzle outlet (e.g., 214, 314, etc. not shown). Those skilled in the art will recognize that other adjustment features for adjusting the relative position of the compaction member 816 are application within the scope of the disclosure, such as a linear actuator or a servo motor. While the adjustment mechanism 832 can be used as a deployment mechanism and vice versa, a general design principle of the adjustment mechanism differs from a deployment mechanism in that a deployment mechanism is intended to extended or retract the compaction member(s) position while the adjustment mechanism 832 has more resolution for position control. A controller (e.g., control system 627 described above or a separate control system, not shown) may be employed to control the adjustment mechanism 832. The adjustment mechanism 832 operates to fine-tune the position of the compaction member 816 during the additive manufacturing material deposition process, thereby controlling certain characteristics of newly deposited additive manufacturing material. Despite having comparatively higher positional control resolution, a linear actuator, a stepper motor, or a servo motor in some embodiments functions as both an adjustment mechanism and a deployment mechanism within the scope of the disclosure. A positional sensor (not shown) may be disposed in a position to provide feedback for control of the position of the compaction member relative to the nozzle outlet (not shown).

While a primary mode of operation for a controller or control system (e.g., 627) may involve controlling the adjustment mechanism 832 to achieve a predetermined height or position for the compaction surface based on desired process outcomes (e.g., target layer thickness), other control strategies are contemplated. For instance, the control system may be configured to control the compaction process based on the amount of applied force rather than, or in combination with, position of the compaction member(s) 816. In such embodiments, the control system may cooperate with force sensors to constitute a closed-loop feedback system Force sensors may include load cells (not shown) integrated with the compaction member 816 or its mounting, to measure the actual compaction force of the compaction member 816 on newly deposited additive manufacturing material. The controller may then command the adjustment mechanism 832 to move the compaction member 816 vertically until a target compaction force or a force within a desired range is achieved. Alternatively, dedicated actuators designed for force control, such as adjustable force pneumatic cylinders (not shown), may be used in embodiments of the additive manufacturing machine either in conjunction with or in place of a (e.g., high-resolution positional) adjustment mechanism 832. Furthermore, the target height or position command sent to the adjustment mechanism 832 need not be static; it can be dynamically determined and updated by the controller based on real-time feedback from various other sensors discussed herein, including thermal feedback (e.g., from pyrometers or IR cameras), visual feedback (e.g., from inspection cameras), or geometric data (e.g., from profile scanners measuring bead dimensions).

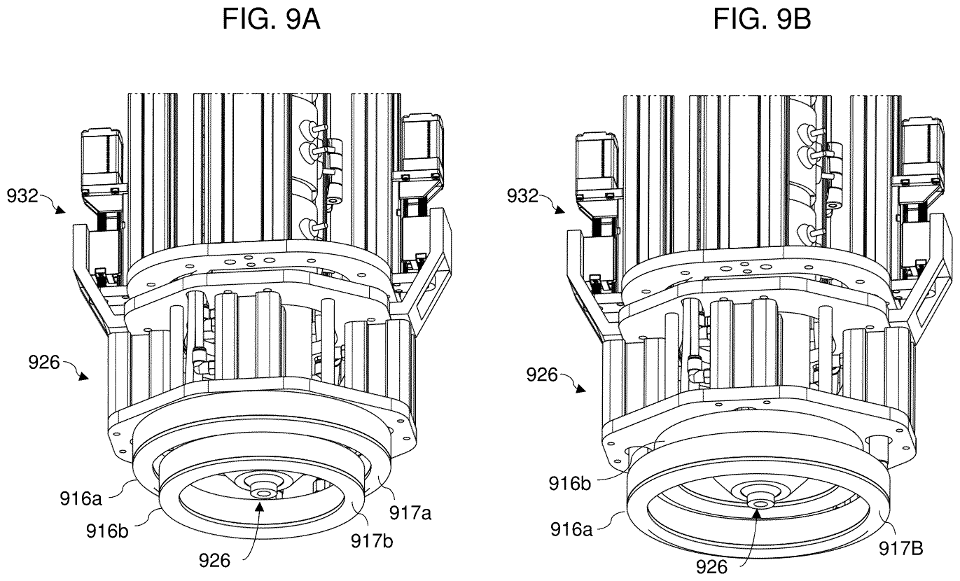

FIGS. 9A and 9B are perspective views of a deposition head 910 having multiple compaction members 916a, 916b and their corresponding compaction surfaces 917a, 917b and both a deployment mechanism 926 and an adjustment mechanism 932. In FIG. 9A, an outer compaction member 916a is in a retracted state while an inner compaction member 916a is in an extended state. In contrast, FIG. 9B illustrates an opposite state, in which the outer compaction member 917a is in an extended state, whereas the inner compaction member 916b is in a retracted state. As described above with respect to the adjustment mechanism 832 in FIG. 8, the adjustment mechanism 932 is responsible for accurately adjusting the position of the compaction member in small increments relative to the deposition nozzle 912. In this embodiment, the adjustment mechanism 932 is configured to control the position of the deployment mechanism 926 and the attached compaction members 916a, 916b. The deployment mechanism 926 is configured to control the discrete compaction member extended or retracted positions. Those skilled in the art will recognize that, alternatively, the deployment mechanism 926 could be replaced with a second adjustment mechanism, and that various combinations of deployment and/or adjustment mechanisms within the scope of this disclosure.

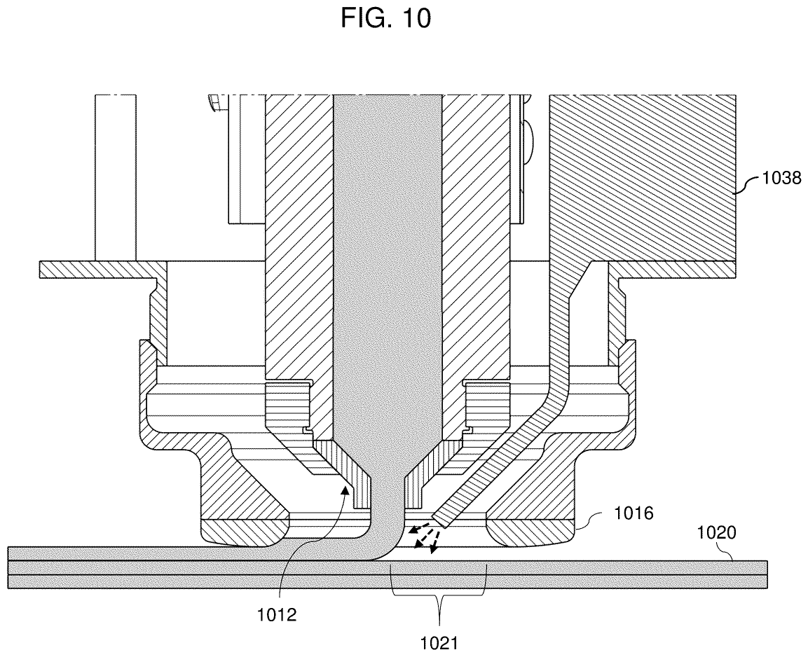

FIG. 10 is a cross-sectional view of a deposition head 1010, deposition nozzle 1012, and compaction member 1016 utilizing a localized heating and/or cooling system 1038. The localized heating and/or cooling system 1038 is configured to selectively heat or cool some, or all, of a region 1021 of the deposition surface 1020 between the nozzle outlet 1016 and the inner surface extent of at least one of the one or more compaction members 1016. This region 1021 may include the deposition surface 1020, substrate, and any newly deposited additive manufacturing material present within that space prior to full compaction by the compaction member 1016. The localized heating and/or cooling system 1038 may employ various heating and cooling technologies, including but not limited to infrared heaters, laser heaters, hot air jets, induction heating, forced air cooling, thermoelectric coolers, and liquid cooling. For simplicity in illustrating the localized heating/cooling feature, FIG. 10 shows a localized heating and/or cooling system 1038 on only one side of the deposition nozzle 1012. However, those skilled in the art will recognize that other localized heating and cooling technologies may be used and that the heating or cooling system can be configured to substantially surround the deposition nozzle 1012 or, alternatively, surround only a portion or portions of the deposition nozzle 1012. In the latter case, the localized heating and/or cooling system 1038 may be positioned or moved during operation to specific locations relative to the nozzle outlet, the expected deposition path, or the compaction member(s) 1016. A shield (not shown) may be disposed with the localized heating or cooling system 1038 to prevent overheating or damage to components of the deposition head, the workpiece, or both.

Furthermore, temperature sensors (not shown), including but not limited to contact type sensors—like thermocouples and Resistance Temperature Detectors (RTDs), and/or non-contact type sensors like pyrometers, fiber optic temperature sensors, and thermal imaging systems (e.g., infrared (IR) cameras)—can be used for thermal feedback to enable closed-loop temperature control. In addition to thermal sensors, other sensor types (not shown) may be employed, such as inspection cameras (providing visual or geometric data); laser displacement sensors, linear variable differential transformers (LVDTs), and encoders (providing positional feedback of the compaction member or actuators); profile scanners like profilometers, laser line scanners and/or structured light systems (providing substrate or deposited material geometry data); load cells and/or strain gauges (providing compaction force data). The physical arrangement of such sensor(s) can vary. In some embodiments, certain sensors or arrays of sensors may be configured to substantially surround the nozzle outlet to monitor conditions around a significant portion of the nozzle perimeter. This surrounding configuration, analogous to the compaction surface arrangement described above, is beneficial for capturing data consistently during poly-directional movement of the deposition head. In some embodiments consistent with the disclosure, the deposition head may be fitted with a sensor repositioning system configured to position or move one or more sensor(s) during operation to prescribed locations relative to the nozzle outlet, the expected deposition path, or the compaction member(s) for targeted monitoring of critical points or zones, such as measuring temperature or geometry of the substrate and/or deposition surface along the deposition path in advance of the nozzle outlet (the leading region) or measuring the temperature or geometry of the newly deposited additive manufacturing material along the deposition path behind the nozzle outlet (the trailing region).

Sensor feedback, whether from surrounding, discretely placed, or dynamically moved sensor(s) can be used to measure one or more locations or parameters, such as: the compaction member(s), the compaction surface(s) (including potentially distinct zones thereof), the substrate, the nozzle outlet, material within the deposition head or path prior to exiting the nozzle, the newly deposited additive manufacturing material (at various points after deposition), and/or the ambient environment in the vicinity of deposition. The feedback from any combination of these sensors can also be used together with the control system (not shown) for closed loop control and to dynamically adjust a variety of process parameters in near real-time during the process itself to mitigate transient process variations or drifts. Adjustable parameters may include, but are not limited to: deposition rate of additive manufacturing material, vertical position (height) of the compaction member(s) (thereby determining the height of the compaction surface(s)) relative to the nozzle or substrate), an applied compaction force (which can be actively modulated or controlled via position); the selection, deployment, or retraction state of specific compaction members (in multi-member configurations, e.g., FIGS. 6, 9); the deposition head's speed along the deposition path; energy output, power level, and/or fluid flow rate supplied to thermal management systems (such as integrated compaction member heating/cooling systems, e.g., FIGS. 3, 7, or localized heating/cooling systems, e.g., FIG. 10); or even minor adjustments to the deposition head's movement along the deposition path itself for error correction.

Beyond being used for closed-loop control or dynamic feedback to the controller, the collected sensor data can be systematically stored for detailed process analysis. This stored data provides a valuable resource for multiple purposes, including quality control and assurance, by allowing for the correlation of specific sensor readings during deposition with the final properties, dimensional accuracy, or defect occurrences in the manufactured part, thereby enabling verification that the process operated within desired specifications. Additionally, the stored data facilitates detailed troubleshooting and diagnostics, permitting examination of the sensor data log after a build failure or the discovery of an anomaly to pinpoint the root cause by identifying deviations in measured parameters at specific times or locations. Furthermore, analyzing data trends across single or multiple builds enables process optimization through understanding the influence of various parameters, identifying sources of variability, and refining operating conditions to improve yield, throughput, material usage, or final part quality. The empirical data can also support the validation, calibration, or development of predictive computational models, such as simulations or digital twins, of the additive manufacturing process, and moreover, it allows for the creation of a comprehensive digital record of the manufacturing conditions for each part, which can be used for documentation and compliance purposes.

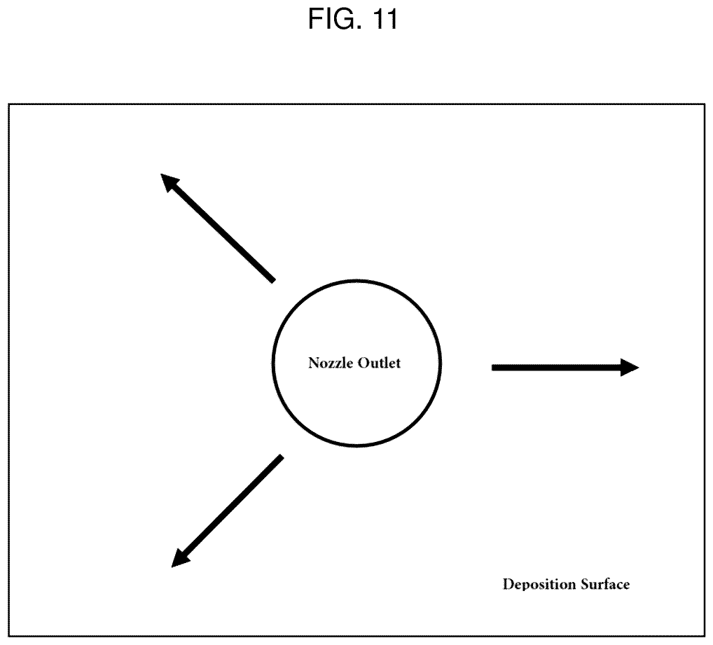

FIG. 11 is a simplified top-down view of a nozzle outlet (e.g., 114, 214, etc.) contained within a deposition head (not shown, e.g., 110, 210, etc.), showing an example of poly-directional movement of the deposition head and its corresponding nozzle outlet. Poly directional movement includes movement in any direction of a plane that is the deposition surface plane. Three discrete directions are shown of the infinite directional possibilities. The term “poly-directional” as used herein typically refers to direction of the deposition head with respect to a deposition path. A deposition head may move (e.g., via a motion system) in at least two dimensions as shown in FIG. 11 (and in a third dimension in some embodiments) to place the deposition nozzle in a desired position along a deposition path. In some poly-directional AMM systems, the deposition head may have a fixed orientation, meaning the deposition head does not rotate, or rotates minimally, while it travels in any direction (“poly-directionally”) in two or three spatial dimensions such that just-deposited additive manufacturing material may leave the nozzle outlet toward any side of the deposition nozzle. It is these systems for which the disclosed compaction member is particularly beneficial. In comparison, a “steerable” type deposition head turns as it deposits material such that additive manufacturing material is always behind the same portion of the traveling deposition nozzle as it follows a deposition path. Similarly, a deposition head may be configured to only deposit material while traveling in a single orientation of travel. Consequently, a compaction member for such steerable systems or single direction systems, if used at all, need only correspond to a narrow path.

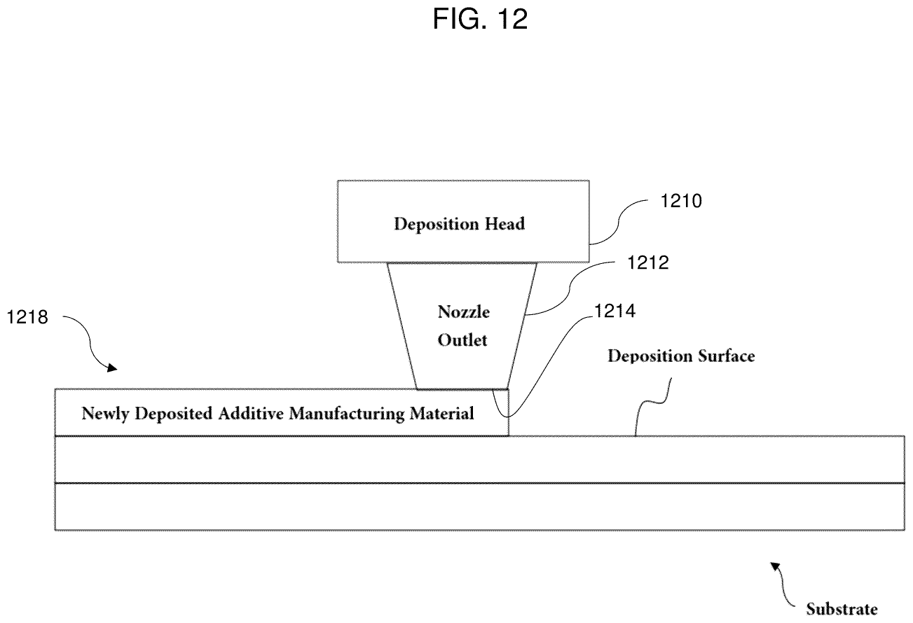

FIG. 12 is a simplified side view of a deposition head 1210 that includes a deposition nozzle 1212 having a nozzle outlet 1214, and a workpiece 1218 which may include newly deposited additive manufacturing material, substrate, and/or deposition surface. To facilitate description of underlying elements FIG. 12 does not include a compaction member described in embodiments above. The term “newly deposited manufacturing material” as used herein refers to additive manufacturing material that has most recently exited from the nozzle outlet 1214. The term “substrate” as used herein includes structure or material located immediately beneath the layer of newly deposited manufacturing material. The term “substrate” as used herein may thus include previously deposited additive manufacturing material (i.e., deposited during a previous deposition pass), support tooling, a previously manufactured part, scaffold, and/or a build plate. The term “deposition surface” is defined as a surface that the newly deposited manufacturing material is extruded upon. The deposition surface is a surface of the substrate. While FIG. 12 shows each of these items in a horizontal plane, a deposition surface can be oriented in any plane while maintaining their same general relationship with one another.

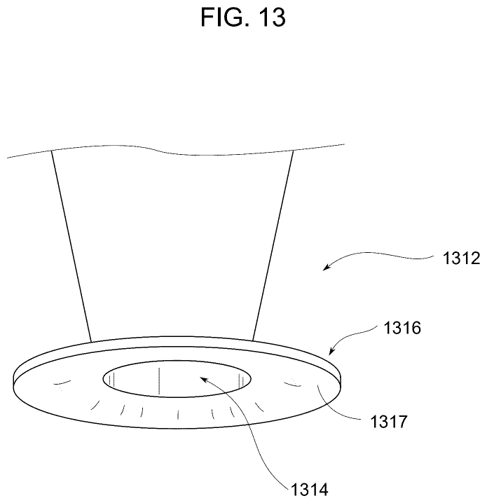

FIG. 13 is a partial perspective view of a deposition nozzle 1312, according to an embodiment. The deposition nozzle 1312 may include a substantially surrounding integrated compaction member (or members) 1316 that slopes (or “ramps”) away from the nozzle outlet 1314 to a compaction surface 1317. The transition from the nozzle outlet 1314 to the compaction surface 1317 may be fully enclosed or may include a thermal break, ventilation, or active cooling (not shown) to permit thermal relief enabling the nozzle outlet to remain heated while the compaction surface remains cooled. Although the illustrated embodiment shows a monolithic compaction member 1316, consistent with the disclosure the compaction member may comprise plural compaction surfaces, may be formed less than fully around the nozzle outlet 1314, and may be one of plural compaction members (such as concentric compaction members as illustrated in, e.g., FIGS. 9A, 9B). The compaction surface 1317 of the integrated compaction member 1316 may be formed a non-zero lateral distance from the nozzle outlet 1314 to accommodate the ramping surface, and permit some thermal stabilization. As discussed above with respect to other embodiments, the compaction surface 1317 may be formed of or treated with surface preparations to manage friction and wear. The compaction member(s) 1316 may include heating and/or cooling features as discussed above for other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Exemplary embodiments are shown and described in the present disclosure. It is to be understood that the embodiments are capable of use in various other combinations and environments and are capable of changes or modifications within the scope of the inventive concept as expressed herein. Some such variations may include using programs stored on non-transitory computer-readable media to enable computers and/or computer systems to carry out part of or all the method variations discussed above. Such variations are not to be regarded as departure from the spirit and scope of the present disclosure, and all such modifications as would be obvious to one skilled in the art are intended to be included within the scope of the following claims.

What is claimed is:

1. An additive manufacturing machine (AMM) comprising:
a deposition head having a deposition nozzle, the deposition nozzle having a nozzle outlet, the deposition head configured to deposit additive manufacturing material through the nozzle outlet onto a deposition surface;
a motion system operationally coupled to the deposition head, the motion system configured to position and move the deposition head with multiple degrees of freedom along a poly-directional deposition path in at least two dimensions for the deposition of the additive manufacturing material; and
one or more compaction members, each having at least one compaction surface, the at least one compaction surface, individually or collectively, being disposed at least 270 degrees around the nozzle outlet, wherein
a first plane that includes at least a portion of the at least one compaction surface closest to the deposition surface is spaced from a second plane, parallel to the first plane, that includes a portion of the nozzle outlet farthest from the deposition surface and/or the at least one compaction surface is disposed a nonzero distance from the nozzle outlet, and
the one or more compaction members is, individually or collectively, oriented to compact the additive manufacturing material newly deposited by the deposition nozzle as the deposition head is moved along the deposition path.

2. The additive manufacturing machine of claim 1, wherein the one or more compaction members are configured to compact the newly deposited additive manufacturing material in each of a plurality of directions of movement of the deposition head relative to the deposition surface.

3. The additive manufacturing machine of claim 1, wherein the at least one compaction surface, individually or collectively, is disposed 360 degrees around the nozzle outlet.

4. The additive manufacturing machine of claim 1, wherein at least a portion of the at least one compaction surface is arranged at a predetermined height relative to the nozzle outlet.

5. The additive manufacturing machine of claim 4, wherein the arrangement at the predetermined height positions a plane of the at least a portion of the at least one compaction surface between the nozzle outlet and the deposition surface at least while the additive manufacturing material is being deposited onto the deposition surface by the deposition nozzle along the deposition path.

6. The additive manufacturing machine of claim 1, wherein at least one of the one or more compaction members includes a heating system, a cooling system, or a heating system and a cooling system.

7. The additive manufacturing machine of claim 1, wherein at least one of the one or more compaction members is formed substantially of a metal, a polymer, or a ceramic material.

8. The additive manufacturing machine of claim 1, wherein the at least one compaction surface includes a surface coating.

9. The additive manufacturing machine of claim 8, wherein the surface coating is selected to reduce friction and adhesion between the deposited additive manufacturing material and the at least one compaction surface, or is selected to improve wear resistance of the at least one compaction surface.

10. The additive manufacturing machine of claim 1, further comprising a localized heating or cooling system configured to heat or cool at least a portion of the deposition surface between the nozzle outlet and at least a portion of the at least one compaction surface while the additive manufacturing material is being deposited along the deposition path.

11. The additive manufacturing machine of claim 1, wherein a distance between a first portion of the at least one compaction surface and a plane defined by the deposition path is greater than a distance between a second, bottom-most portion, of the at least one compaction surface and the plane, the second portion being positioned farther from the nozzle output than the first portion, a profile of the at least one compaction surface between the first portion and the second portion causing the compaction member to gradually apply compaction force to the newly deposited additive manufacturing material as the deposition head moves.

12. The additive manufacturing machine of claim 1, further comprising an adjustment mechanism configured to adjust the height of one or more of the at least one compaction surfaces relative to the nozzle outlet, a deployment mechanism configured to deploy or retract one or more of the compaction members, or both the adjustment mechanism and the deployment mechanism.

13. The additive manufacturing machine of claim 12, wherein the adjustment mechanism includes at least one of: a linear actuator, a stepper motor, and a servo motor.

14. The additive manufacturing machine of claim 1, further comprising a control system configured to control one or more operational parameters including at least one of:
an additive manufacturing material deposition rate,
a deposition head traversal speed,
a height of the one or more compaction surfaces relative to the nozzle outlet,
an applied compaction force,
a deployment state of the one or more compaction members, and
energy output of one or more thermal management systems operable to control temperature associated with at least one of:
the deposition head,
the deposition nozzle,
the one or more compaction members,
the one or more compaction surfaces, and
a region of the deposition surface between the nozzle outlet and the at least one compaction surface.

15. The additive manufacturing machine of claim 14, wherein the control of the at least one or more operational parameters is based on at least one of: historical data from previous layers of deposited additive manufacturing material, predicted requirements based on upcoming geometry of the deposition path, and anticipated behavior of the additive manufacturing material.

16. The additive manufacturing machine of claim 14, further comprising one or more sensors configured to collect feedback data and provide the feedback data to the control system, the one or more sensors including at least one sensor selected from the group consisting of: an inspection camera, a laser displacement sensor, a profile scanner, a temperature sensor, and a load cell.

17. The additive manufacturing machine of claim 16, wherein the control system is configured to dynamically adjust at least one or more operational parameters based at least in part on the feedback data from the one or more sensors.

18. The additive manufacturing machine of claim 1, wherein the deposition head and deposition nozzle are configured to handle the additive manufacturing material when the additive manufacturing material includes one of: pelletized materials, filamentary materials, paste-like materials, wire materials, powdered materials, or flowable materials extrudable through the deposition nozzle.

19. The additive manufacturing machine of claim 1, wherein the one or more compaction surfaces includes a plurality of the compaction surfaces, each compaction surface having respectively one or more different characteristics compared to another of the compaction surfaces, the respectively different characteristics including one or more of: surface material, ramp angle, diameter, surface coating, surface finish, distance from the nozzle outlet, and temperature.

20. The additive manufacturing machine of claim 1, wherein at least one of the one or more compaction members is integrated with the deposition nozzle, and at least a portion of the at least one compaction surface is contiguous with an edge of the nozzle outlet.

21. A deposition head for additive manufacturing, the deposition head comprising:
a deposition nozzle having a nozzle outlet, the deposition head configured to deposit additive manufacturing material through the nozzle outlet; and
one or more compaction members, each having at least one compaction surface, the at least one compaction surface, individually or collectively, being disposed at least 270 degrees around the nozzle outlet, wherein
a first plane that includes at least a portion of the at least one compaction surface closest to an intended deposition surface during operation is spaced from a second plane, parallel to the first plane, that includes a portion of the nozzle outlet farthest from the intended deposition surface during operation and/or the at least one compaction surface is disposed a nonzero distance from the nozzle outlet.

22. The deposition head of claim 21, wherein the one or more compaction members are, individually or collectively, oriented relative to the deposition nozzle to compact additive manufacturing material newly deposited by the deposition nozzle.

23. The deposition head of claim 21, wherein the one or more compaction members are configured to compact the newly deposited additive manufacturing material in each of a plurality of directions of movement of the deposition head relative to the deposition surface.

24. The deposition head of claim 21, wherein the at least one compaction surface, individually or collectively, is disposed 360 degrees around the nozzle outlet.

25. The deposition head of claim 21, wherein at least a portion of the at least one compaction surface is arranged at a predetermined height relative to the nozzle outlet.

26. The deposition head of claim 25, wherein the arrangement at the predetermined height positions a plane of the at least a portion of the at least one compaction surface between the nozzle outlet and the deposition surface at least while the additive manufacturing material is being deposited onto the intended deposition surface by the deposition nozzle along a deposition path.

27. The deposition head of claim 21, wherein at least one of the one or more compaction members includes a heating system, a cooling system, or a heating system and a cooling system.

28. The deposition head of claim 21, wherein at least one of the one or more compaction members is formed substantially of a metal, a polymer, or a ceramic material.

29. The deposition head of claim 21, wherein the deposition head and deposition nozzle are configured to handle the additive manufacturing material when the additive manufacturing material includes one of: pelletized materials, filamentary materials, paste-like materials, wire materials, powdered materials, or flowable materials extrudable through the deposition nozzle.

30. The deposition head of claim 21, wherein at least one of the one or more compaction members is integrated with the deposition nozzle, and at least a portion of the at least one compaction surface is contiguous with an edge of the nozzle outlet.

31. The deposition head of claim 21, wherein a distance between a first portion of the at least one compaction surface and a plane defined by a deposition path is greater than a distance between a second, bottom-most portion, of the at least one compaction surface and the plane, the second portion being positioned farther from the nozzle output than the first portion, a profile of the at least one compaction surface between the first portion and the second portion causing the compaction member to gradually apply compaction force to the newly deposited additive manufacturing material as the deposition head moves.

32. A method of additive manufacturing, comprising:
providing an additive manufacturing machine (AMM) having:
a deposition head with a nozzle outlet,
a motion system configured to move the deposition head in multiple degrees of freedom, and
one or more compaction members, each having at least one compaction surface, the compaction surfaces, individually or collectively, substantially surrounding the nozzle outlet;
moving the deposition head in multiple degrees of freedom using the motion system;
depositing additive manufacturing material from the nozzle outlet onto a deposition surface; and
compacting the newly deposited material with at least one compaction surface during poly-directional movement of the deposition head effected by the motion system.
